(19) United States
(12) Patent Application Publication
(10) Pub. No.: US 2004/0252352 A1
(43) Pub. Date: Dec. 16, 2004

(54) Method of scanning a document in two directions

(76) Inventors: Po-Chih Chang, Taipei Hsien (TW); Chih-Ching Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/460,386

(22) Filed: Jun. 13, 2003

(51) Int. Cl. H04N 1/04; G06K 9/00

(52) U.S. Cl. 358/474; 358/486; 358/497; 382/318

(57) ABSTRACT

A method for scanning a document with a scanner electrically connected to a host computer. The scanner includes a scanning module for scanning the document and a motor for driving the scanning module. The method includes the motor driving the scanning module in a first direction, scanning a first set of alternating lines of the document in the first direction with the scanning module, the motor driving the scanning module in a second direction, scanning a second set of alternating lines of the document in the second direction with the scanning module, outputting image data from the first and second sets of alternating lines to the host computer, and combining the image data from the first and second sets of alternating lines into a scanned image of the document using imaging software installed on the host computer.

### BACKGROUND OF INVENTION

1. Field of the Invention

The present invention relates to a scanning apparatus, and more specifically, to a method of using a scanning apparatus to scan a document in two directions.

2. Description of the Prior Art

Image scanners such as flat bed scanners or paper fed scanners are commonly used in a home or office environment for scanning documents into computers. A scanner scans a document line by line, and then image data is transmitted from the scanner to a host computer connected to the scanner.

Please refer to FIG. 1. FIG. 1 illustrates a scanner 10 connected to a host computer 20 according to the prior art. The scanner 10 comprises a scanning module 12 used for scanning a document, a motor 16 for driving the scanning module 12 left and right inside the scanner 10, and a control circuit 14 for controlling operation of the scanning module 12 and the motor 16. The motor 16 is typically a step motor, which controls the scanning module 12 to move line by line while scanning the document. Imaging software 22 is installed on the host computer 20 for viewing and editing images created by the scanner 10.

Please refer to FIG. 2 through FIG. 4. FIG. 2 is a flowchart illustrating a method of scanning according to the prior art. FIG. 3 and FIG. 4 show a document 100 being scanned according to the prior art method. Steps in the prior art method will be explained below.

Step 200: Start;

Step 202: The motor 16 drives the scanning module 12 in a first direction 101;

Step 204: The scanning module 12 scans the entire document 100 while traveling in the first direction 101;

Step 206: The motor 16 drives the scanning module 12 in a second direction 102;

Step 208: A scanned image of the document 100 is outputted from the scanner 10 to the host computer 20; and

Step 210: End.

For simplicity, the document 100 in FIG. 3 and FIG. 4 is shown as having five lines: a first line 110, a second line 120, a third line 130, a fourth line 140, and a fifth line 150. In FIG. 3, the scanning module 12 is shown as resting in an initial position. In step 204, the scanning module 12 moves in the first direction 101 and scans the entire document. Therefore the first line 110, the second line 120, the third line 130, the fourth line 140, and the fifth line 150 are all scanned in one step.

After step 204 is completed, the scanning module 12 rests in an ending position, as shown in FIG. 4. In step 206, the motor 16 drives the scanning module 12 to move in the second direction 102 and return to the initial position. Notice that the scanning module 12 only scans the document 100 while traveling in the first direction 101 and not in the second direction 102.

Unfortunately, time is required for the scanning module 12 to travel along the second direction 102 from the ending position to the initial position, and no scanning is accomplished during this time. As an example, suppose that the document 100 is a standard A4 size piece of paper. If the scanner 10 scans the document 100 at 600 dpi (dots per inch), 30 seconds are typically required for the scanning module 12 to scan the document 100 while traveling in the first direction 101. Next, at least 2 to 3 additional seconds are needed for the scanning module 12 to travel in the second direction 102 in order to return to the initial position. Top scanners on the market today are capable of making the return trip in the second direction 102 in only 2 to 3 seconds. Therefore, older or lower performance scanners can take far longer than this to make the return trip. Because of this wasted time, a longer amount of time is needed to scan a large amount of documents using the prior art method of scanning.

### SUMMARY OF INVENTION

It is therefore a primary objective of the claimed invention to provide a method for scanning a document in two directions in order to solve the above-mentioned problems.

According to the claimed invention, a method for scanning a document with a scanner electrically connected to a host computer is disclosed. The scanner includes a scanning module for scanning the document and a motor for driving the scanning module. The method includes the motor driving the scanning module in a first direction, scanning a first set of alternating lines of the document in the first direction with the scanning module, the motor driving the scanning module in a second direction, scanning a second set of alternating lines of the document in the second direction with the scanning module, outputting image data from the first and second sets of alternating lines to the host computer, and combining the image data from the first and second sets of alternating lines into a scanned image of the document using imaging software installed on the host computer.

It is an advantage of the claimed invention that scanner scans part of the document during while traveling in the first direction and scans the rest of the document while traveling in the second direction so that the scanning module is able to quickly scan in both the first and second directions, and no time is wasted.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 illustrates a scanner connected to a host computer according to the prior art.

FIG. 2 is a flowchart illustrating a method of scanning according to the prior art.

FIG. 3 and FIG. 4 show a document being scanned according to the prior art method.

FIG. 5 is a flowchart illustrating a method of scanning according to the present invention.

FIG. 6 and FIG. 7 show a document being scanned according to the present invention method.

### DETAILED DESCRIPTION

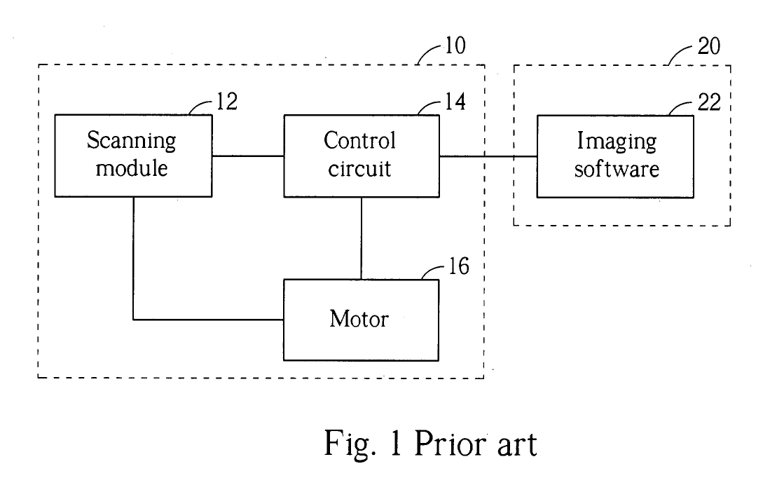

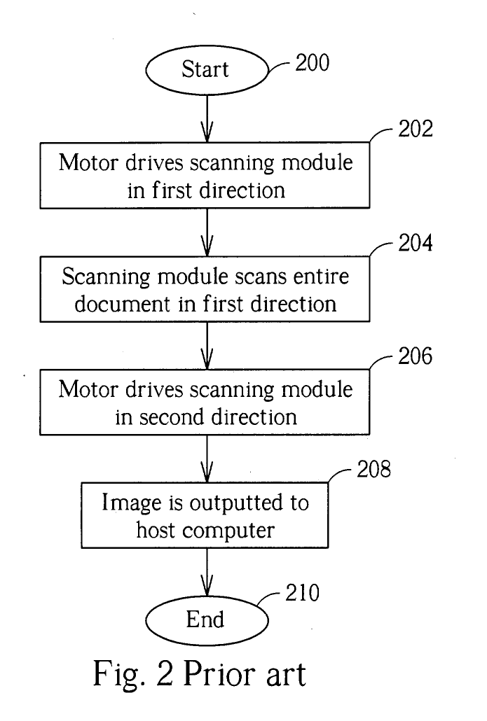

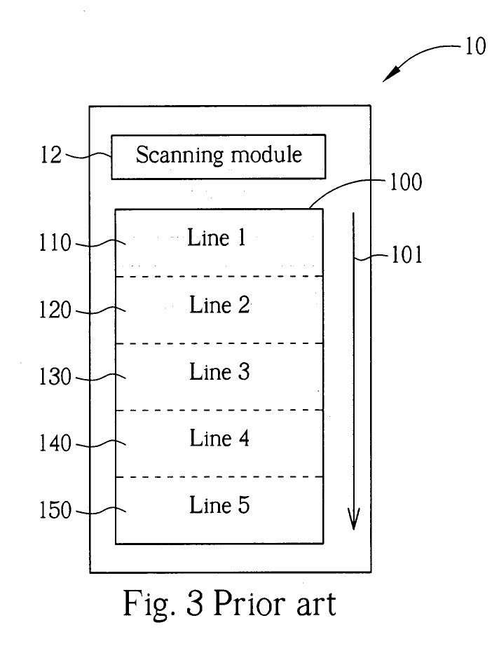

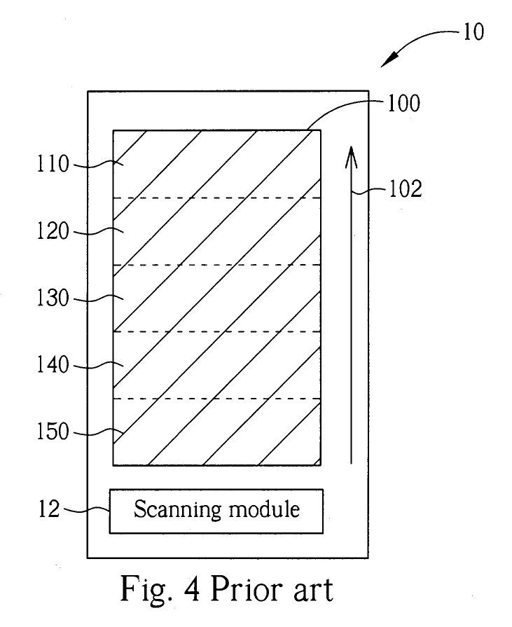

The scanner 10 and host computer 20 shown in FIG. 1 will also be used in the description of the present invention. Since only the method of scanning is different between the prior art and the present invention, identical reference numbers will be used.

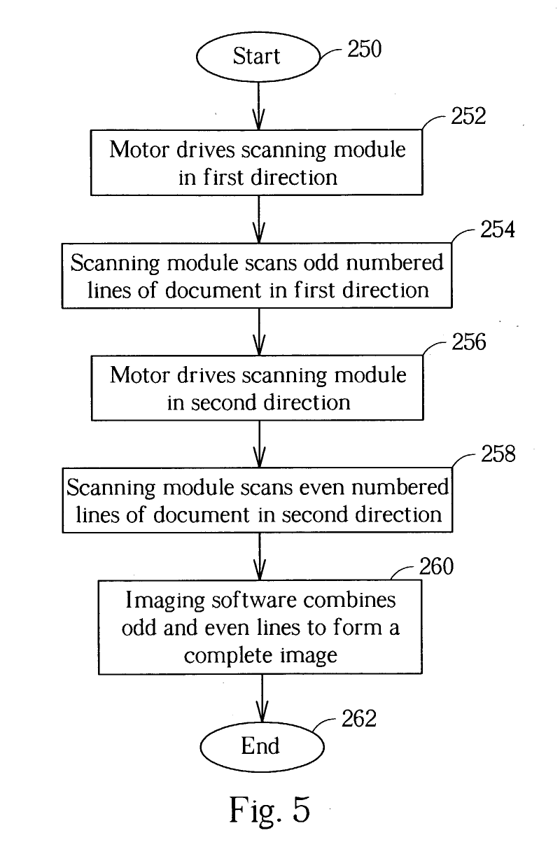

Please refer to FIG. 5. FIG. 5 is a flowchart illustrating a method of scanning according to the present invention. Steps in the present invention method will be explained below.

Step 250: Start;

Step 252: The motor 16 drives the scanning module 12 in a first direction 101;

Step 254: The scanning module 12 scans the odd numbered lines of the document 100 while traveling in the first direction 101;

Step 256: The motor 16 drives the scanning module 12 in a second direction 102;

Step 258: The scanning module 12 scans the even numbered lines of the document 100 while traveling in the second direction 102;

Step 260: Imaging software 22 on the host computer 20 combines the image data from the odd and even lines to form a complete scanned image; and

Step 262: End.

The image software used to combine the odd and even lines can reside on the scanner 10 or on the host computer 20. If the image software is located on the scanner 10, the odd and even lines can be combined immediately after the scanner 10 finishes scanning in the first and second directions 101, 102. If the image software resides on the host computer 20, the image data from the odd and even lines is first outputted to the host computer 20 and the image software then combines the data to form the complete scanned image.

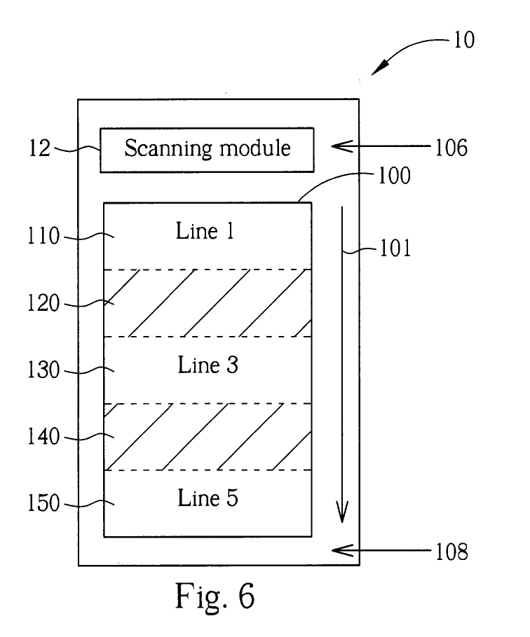

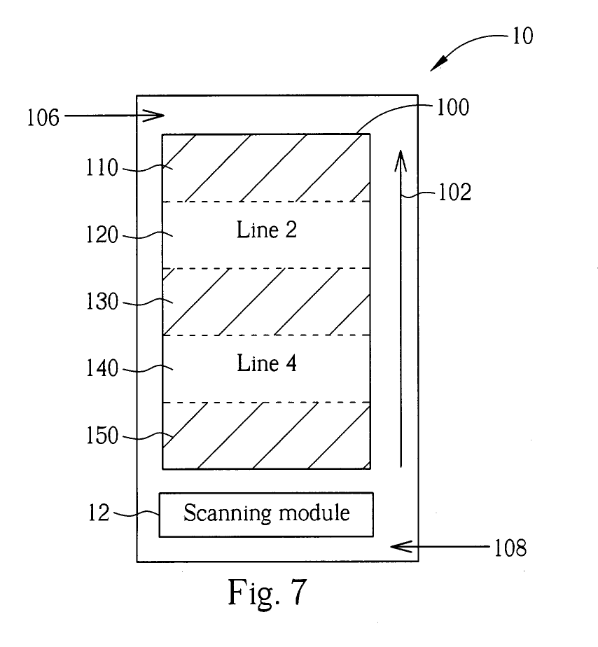

Please refer to FIG. 6 and FIG. 7. FIG. 6 and FIG. 7 show the document 100 being scanned according to the present invention method. In FIG. 6, the scanning module 12 is shown at a home position 106. As with step 252 above, in FIG. 6 the motor 16, such as a step motor or DC motor drives the scanning module 12 in the first direction 101. The scanning module 12 then scans the odd lines of the document 100 while moving in the first direction 101. In FIG. 5, since only five lines are shown as an example, the first line 110, the third line 130, and the fifth line 150 are all scanned. After the odd lines are scanned, the scanning module 12 is at an end position 108. Then, as with step 256, in FIG. 7 the motor 16 drives the scanning module 12 in the second direction 102. The scanning module 12 then scans the even lines of the document while moving in the second direction 102. In this example, the second line 120 and the fourth line 140 are scanned. Finally, after the even lines are scanned, the scanning module 12 returns to the home position 106. Please note that the scanning module 12 is not limited in moving between the home position 106 and the end position 108. The scanning module 12 can move between any first and second positions in the scanner. Any document or image located between the first and second positions can be scanned in the first direction 101 and the second direction 102 according to the process described above.

After the odd and even lines of the document 100 have been scanned, the scanner 10 outputs image data from the odd and even lines to the host computer 20. The imaging software 22 on the host computer then receives the image data from the odd and even lines, and combines the data to form a complete image. That is, the image data is combined in the correct order such that the completed image resembles the original document 100 that was scanned.

Using the present invention method for scanning a document, significant time savings can be realized. As a reminder, the example given above shows that the prior art method usually requires 30 seconds for the scanning module 12 to scan the document 100 while traveling in the first direction 101 if the document is A4 size and the document 100 is being scanned at 600 dpi. Next, at least 2 to 3 additional seconds are needed for the scanning module 12 to travel in the second direction 102 in order to return to the initial position. However, the present invention can effectively eliminate the extra 2 to 3 seconds at the end of the prior art scanning procedure.

With the present invention operating under comparable conditions, since only the odd lines are scanned in the first direction, only 15 seconds are needed while the scanning module 12 scans the odd lines. The motor 16 is able to move the scanning module 12 at a rate twice as fast as that of the prior art since only half of the lines of the document 100 are being scanned and less data is being processed by the scanner 10. Next, the motor 16 requires a few milliseconds to reverse direction and move the scanning module 12 in the second direction 102. An additional 15 seconds are then required for scanning the even lines in the second direction 102. All together, 30 seconds plus a few milliseconds are required to scan the document 100 using the present invention method. This is in contrast to the prior art method which takes 30 seconds plus 2 to 3 seconds. In effect, 2 to 3 seconds are shaved off of the scanning process by using the present invention method.

The present invention method can also be implemented by scanning the even lines of the document before the odd lines of the document. As long as every other line of the document 100 is scanned in each direction that the scanning module 12 moves in, the scanning module 12 can travel at a rate twice as fast as that of the prior art. Moreover, the scanning module 12 is scanning image data in both the first direction 101 and the second direction 102. This is a more efficient approach than the prior art method which only scans data in the first direction 101 and performs no work while traveling in the second direction 102.

Perhaps the best advantage of the prior art is that any existing scanning apparatus, such as a scanner or multi-functional peripheral (MFP), can be modified to use the present invention method through a firmware update. With an updated firmware, the scanning apparatus can be controlled to scan according to the present invention method since all of the hardware of the existing scanning apparatus such as the motor and scanning module is also used in the present invention scanner.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of scanning a document comprises the steps of:
scanning a first set of alternating lines of the document in a first direction;
scanning a second set of alternating lines of the document in a second direction; and
combining the image data from the first and second sets of alternating lines into a scanned image of the document.

2. The method of claim 1 wherein the first set of alternating lines of the document consists of odd numbered lines of the document and the second set of alternating lines of the document consists of even numbered lines of the document.

3. The method of claim 1 wherein the first set of alternating lines of the document consists of even numbered lines of the document and the second set of alternating lines of the document consists of odd numbered lines of the document.

4. The method of claim 1 wherein the image data from the first and second sets of alternating lines are combined by interlacing the first set of alternating lines with the second set of alternating lines to form the scanned image.

5. The method of claim 1 further comprising scanning the document with a scanning apparatus, the scanning apparatus comprising a scanning module for scanning the document and a motor for driving the scanning module.

6. The method of claim 5 wherein the motor drives the scanning module to scan in the first direction and in the second direction.

7. The method of claim 5 further comprising outputting image data from the first and second sets of alternating lines from the scanning apparatus to a host computer electrically coupled to the scanning apparatus.

8. The method of claim 7 wherein the host computer further comprises imaging software for combining the image data into the scanned image of the document.

9. The method of claim 5 wherein the scanning apparatus further comprises imaging software for combining the image data into the scanned image of the document.

10. The method of claim 5 wherein the scanning module begins scanning the first set of alternating lines at a home position, and scans in the first direction until an end position.

11. The method of claim 10 wherein the scanning module begins scanning the second set of alternating lines at the end position, and scans in the second direction until the home position.

12. The method of claim 1 wherein the step of scanning in the first direction begins at a first position, and scans in the first direction until a second position.

13. The method of claim 12 wherein the step of scanning in the second direction begins at the second position, and scans in the second direction until the first position.

14. The method of claim 5 wherein the motor is a step motor.

15. The method of claim 5 wherein the motor is a DC motor.
